(19) United States
(12) Patent Application Publication
(10) Pub. No.: US 2021/0380302 A1
(43) Pub. Date: Dec. 9, 2021

(54) Method and Apparatus for Application of Polymeric Film and Laminates to Surfaces of Articles

(71) Applicant: ENTROTECH, INC., Columbus, OH (US)

(72) Inventor: James E. McGUIRE, JR., Palm Beach, FL (US)

(73) Assignee: entrotech, inc., Columbus, OH (US)

(21) Appl. No.: 17/290,487

(22) PCT Filed: Oct. 31, 2019
(86) PCT No.: PCT/US2019/059167

§ 371 Date: Apr. 30, 2021

Related U.S. Application Data
(60) Provisional application No. 62/754,480, filed on Nov. 1, 2018.

(51) Int. Cl. B65B 67/08; B65B 11/02; B65B 59/02

(52) U.S. Cl. CPC B65B 67/08; B65B 2210/18; B65B 59/02; B65B 11/025

(57) ABSTRACT

Unwind assembly fixtures herein are useful in improved methods for application of polymeric film or laminate to at least a portion of a surface of an article. In an exemplary embodiment, such a method comprises: providing an unwind assembly fixture comprising an anti-static device; securing the roll of multi-layer sheet in the fixture; unwinding the multi-layer sheet from the roll; removing the release liner from the multi-layer sheet after it is unwound from the roll; capturing and re-rolling the removed release liner on another roll positioned in the fixture; and applying the polymeric film laminate to the surface of the article.

### CROSS-REFERENCE TO RELATED APPLICATIONS

This application claims the benefit of U.S. Provisional Patent Application No. 62/754,480, filed on Nov. 1, 2018, which is incorporated herein by reference in its entirety.

### BACKGROUND OF THE INVENTION

Application of material to a surface, particularly in bulk processes, often involves use of racks and carts for storage and dispensing of material, particularly when the material is provided in roll form. For example, automotive refinish shops often utilize specialized carts for dispensing masking materials useful in spray painting operations.

Such carts are available, for example, from Innovative Tools & Technologies, Inc. (St. Paul, Minn.), and can be used for storage of relatively basic and disposable paper and plastic materials—e.g., masking tape. If such masking materials include an adhesive layer, the materials are typically self-wound (i.e., without a separable release liner protecting the adhesive layer.) U.S. Pat. No. 10,143,300 describes such exemplary carts.

More specialized polymeric film is becoming increasingly useful in a range of indoor and outdoor applications in, for example, the transportation, architectural and sporting goods industries. It has been found that polymeric films or laminates comprising the same can advantageously be applied to at least a portion of a surface of any article where protection or decoration (e.g., with paint) is desired. Such articles include, for example, motorized vehicles and non-motorized vehicles, amongst a multitude of other applications.

Surfaces on which polymeric films or laminates comprising the same are used can be, for example, painted or unpainted. When a polymeric film or laminate comprising the same is pigmented or otherwise, it can be used itself as “paint in film form” (also referred to as a “paint film applique,” “paint replacement film,” “paint film,” or the like). When a polymeric film or laminate comprising the same is adhered to a surface primarily for the purpose of protecting paint existing on the underlying surface, it is often referred to as a “paint protection film” or the like.

Often polymeric film or laminate comprising the same takes the form of a multi-layer sheet—e.g., one which includes an outwardly exposed adhesive layer for adherence of the polymeric film to a surface of an article. Generally, until its application onto the surface, what would generally be an outwardly exposed adhesive layer in an exemplary multi-layer sheet is covered by a release liner to protect the adhesive layer from becoming contaminated with debris and to facilitate storage and handling of the sheet, which is often provided in roll form. When such a release liner is removed from the adhesive layer so that the sheet can be adhered to the surface, the adhesive layer often accumulates debris that is attracted to that exposed adhesive layer before it is actually applied to the surface. This problem is exacerbated by static charging of the adhesive layer surface during removal of the release liner, which charge arises due to the triboelectric effect and is also referred to as tribocharge.

When applying polymeric film or a laminate comprising the same to articles in a relatively uncontrolled environment—e.g., as opposed to a clean room environment, the triboelectric effect is often intensified and the debris available to be attracted to the adhesive layer is often considerable. For example, when applying polymeric film or laminates comprising the same to marine vessels in open-air boatyards and the like, clean adherence of polymeric film to the surface of the article is often impossible using conventional technology, including racks and carts described above.

The ability to install such films and laminates in a controlled manner is often of great importance, however, in order to maintain a desired or requisite surface finish. More specialized polymeric film and laminates, such as paint in film form and paint protection film described above, are often specifically used for the purpose of creating and/or maintaining certain high-quality surface finishes. Toward that end goal, ways to achieve those surface finishes, such as methods and apparatus for reducing tribocharge during application of polymeric film and laminates comprising the same to a surface of an article, are desired. There exists a particular need for technology, including racks and carts, for adequate storage, handling, and dispensing of adhesive-backed polymeric films and laminates that are supplied with a disposable release liner in multi-layer sheets. Further, there exists a particular need for such technology that is also capable of adequately and efficiently handling release liner scrap that arises during application of such films and laminates onto a surface. Amongst a multitude of others, one reason for the importance of this consideration, for example, is that release liners, having a low coefficient of friction, may present a slipping hazard if they end up on the floor.

While removing and disposing of a release liner from, for example, an adhesive name tag is a relatively trivial process, the removal and disposal process of a release liner from an adhesive layer becomes exponentially more difficult as sheet size increases. The difficulty is particularly pronounced when the sheet is provided in roll form. Using conventional roll storage racks, removal of release liner from large sheets of film and laminate has proven to be quite difficult. A complicating factor is that tables equal to or greater in size than that of the sheet itself must typically be available on which to place a sheet after the desired sheet size has been cut from the roll in order to facilitate application of the sheet to a surface without complications from the unprotected adhesive layer first adhering to itself. The challenging process also typically requires the assistance of multiple installers, increasing labor costs associated with the process.

Further, adequate accommodations are needed to secure a multi-layer sheet in place when removing a release liner from an adhesive layer therein. Also, once a release liner is removed from the adhesive layer within such a sheet, care must be taken in order to ensure that the exposed adhesive surface is not otherwise adversely affected (e.g., by dirt, marring of the adhesive, etc.) As described above, tribocharging that often occurs as a release liner is removed from the adhesive layer of such a sheet makes keeping large surface areas of adhesive free of dirt and debris nearly impossible when dispensing laminates comprising polymeric film for application to a surface of an article.

### SUMMARY OF THE INVENTION

Unwind assembly fixtures of the invention facilitate improved application of polymeric films and polymeric film laminates to surfaces of articles. Such fixtures are particularly useful for dispensing of multi-layer sheets that include an adhesive layer for adherence of the polymeric film in the form of a polymeric film laminate to an article's surface, wherein such an adhesive layer is protected with a release liner until application of the polymeric film laminate to the surface, at which time the release liner is removed.

An exemplary embodiment of such a fixture comprises: first and second longitudinally extending support bars; first and second film holders respectively disposed proximate upper ends of the first and second longitudinally extending support bars; first and second film holder/winder mechanisms respectively disposed proximate lower ends of the first and second longitudinally extending support bars, wherein the second film holder/winder mechanism facilitates unwind of the multi-layer sheet from a roll and the first film holder/winder mechanism facilitates capture and re-rolling of the release liner after its removal from the roll of multi-layer sheet; and an anti-static device positioned approximately parallel to the first and second longitudinally extending support bars and spaced apart from the second support bar on a side opposite the first support bar and proximate a point at which the release liner is removed from the roll of multi-layer sheet during dispensing of the polymeric film laminate for application to the surface of the article.

According to a preferred aspect of this embodiment, the unwind assembly fixture is mounted in a portable manner on a vehicle, such as a mobile lift table. To aid in efficient and effective application of the polymeric film laminate to a surface, such a vehicle can be moved as needed in order to maintain the polymeric film or laminate at the proper height and location with respect to the article for effective and efficient application to a surface of the article.

According to another preferred aspect of this embodiment, at least one of the first and second film holders of the unwind assembly fixture is adjustable. Such adjustability allows for accommodation of rolls of multi-layer sheet having varying core diameters and varying widths of multi-layer sheet.

According to yet another preferred aspect of this embodiment, at least one of the first and second film holder/winder mechanisms utilizes tension control technology to provide controlled dispensing of polymeric film or laminate from the multi-layer sheet. This is accomplished by ensuring that an appropriate tension level occurs as the multi-layer sheet is unwound and the release liner is captured and rewound onto a separate roll after it is removed from the multi-layer sheet.

According to another preferred aspect of this embodiment, the fixture comprises a dispensing mechanism for dispensing of a fluid, steam, or gas onto the exposed adhesive layer of the multi-layer sheet immediately after the release liner is removed therefrom.

Focusing on reduction of tribocharge during application of polymeric film or laminate to a surface of an article, an exemplary unwind assembly fixture comprises: a film holder for mounting of a multi-layer sheet in roll form; and an anti-static device that extends across width of the multi-layer sheet or a portion thereof during unwind of the multi-layer sheet from the roll. According to a preferred aspect of this embodiment, the anti-static device comprises an anti-static bar generating an electrical field for electrical contact of the polymeric film or laminate. According to another preferred aspect of this embodiment, the anti-static bar physically contacts the polymeric film or laminate. To accommodate removal of a release liner from a multi-layer sheet, the fixture further comprises a second film holder for capture and re-rolling of release liner after its removal from the multi-layer sheet.

Unwind assembly fixtures of the invention are useful in improved methods for application of polymeric film or laminate to at least a portion of a surface of an article. In an exemplary embodiment, such a method comprises: providing the first unwind assembly fixture described above; securing the roll of multi-layer sheet between the second film holder and the second film holder/winder mechanism; unwinding the multi-layer sheet from the roll; removing the release liner from the multi-layer sheet after it is unwound from the roll; capturing and re-rolling the removed release liner on a roll positioned between the first film holder/winder mechanism and the first film holder; and applying the polymeric film laminate to the surface of the article.

Using fixtures and methodology of the invention, polymeric film and polymeric film laminates can be more efficiently and effectively applied to a variety of surfaces. In exemplary embodiments, the surfaces are those selected from those on, for example, cargo containers, marine vessels, and land-based passenger vehicles.

### BRIEF DESCRIPTION OF THE SEVERAL VIEWS OF THE DRAWINGS

FIG. 1A is a front right-hand perspective view of an exemplary unwind assembly fixture according to the invention.

FIG. 1B is a front perspective view of the exemplary unwind assembly fixture of FIG. 1A.

FIG. 1C is a back perspective view of the exemplary unwind assembly fixture of FIG. 1A.

FIG. 1D is a left-hand side perspective view of the exemplary unwind assembly fixture of FIG. 1A.

FIG. 1E is a right-hand side perspective view of the exemplary unwind assembly fixture of FIG. 1A.

FIG. 1F is a top perspective view of the exemplary unwind assembly fixture of FIG. 1A.

FIG. 1G is a front left-hand perspective view of the exemplary unwind assembly fixture of FIG. 1A.

FIG. 1H is a back left-hand perspective view of the exemplary unwind assembly fixture of FIG. 1A.

FIG. 1I is a back right-hand perspective view of the exemplary unwind assembly fixture of FIG. 1A.

FIG. 2 is a black-and-white photograph of an exemplary unwind assembly fixture of the invention being used to apply polymeric film to an automobile.

FIG. 3 is a black-and-white photograph of an exemplary unwind assembly fixture of the invention being used to apply polymeric film to a boat hull.

### DETAILED DESCRIPTION OF THE INVENTION

An unwind assembly fixture of the invention is used to unroll multi-layer sheet provided in roll form for application to a surface of an article. In one embodiment, the fixture facilitates not only unroll of the multi-layer sheet, but also removal of at least one layer of material therefrom before application to the surface. Advantageously, amongst other benefits, the unwind assembly fixture enables dispensing and application of the multi-layer sheet with reduced tribocharge in a preferred embodiment. According to such a preferred embodiment, an unwind assembly fixture of the invention comprises a mechanism for mounting of a multi-layer sheet in roll form and an anti-static device extending across the width of the multi-layer sheet or a portion thereof during unwind of the multi-layer sheet from the roll. Although it could be oriented otherwise, the roll of multi-layer sheet is generally suspended vertically or horizontally on the unwind assembly fixture.

The anti-static device comprises any suitable mechanism for neutralizing charge on the polymeric film or laminate comprising the same that is being applied to the surface of the article. In one embodiment, the anti-static device comprises an anti-static bar that generates an electrical field, causing air molecules in the vicinity of the bar to break down into positive and negative ions. The anti-static device contacts the polymeric film or laminate comprising the same at least electrically, and even physically in some embodiments. Charged material (i.e., tribocharged material) passing near the bar will attract ions of opposite charge until charge on the material is neutralized. In this manner, polymeric film or laminate comprising the same can be applied to the surface of the article without conventional complications associated with tribocharge.

According to another aspect of a preferred embodiment of the invention, the unwind assembly fixture also includes a mechanism for capturing and rolling at least one layer (e.g., release liner) removed from the multi-layer sheet before application of polymeric film or a laminate comprising the same to the surface of the article. When present, such a mechanism is generally suspended in the same orientation—generally vertically or horizontally—as the orientation of the roll of multi-layer sheet from which the layer is removed.

The unwind assembly fixture can be mounted in a stationary manner on the ground, on a floor, or the like. In an alternative embodiment, the unwind assembly fixture is mounted in a portable manner on a vehicle, such as a truck or a hand cart (e.g., mobile lift table).

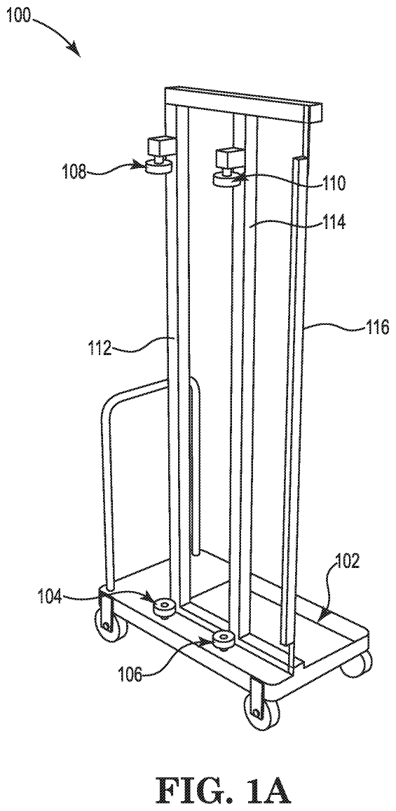

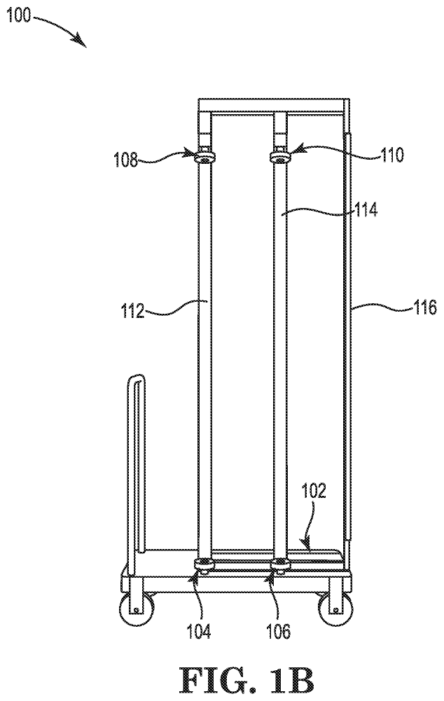

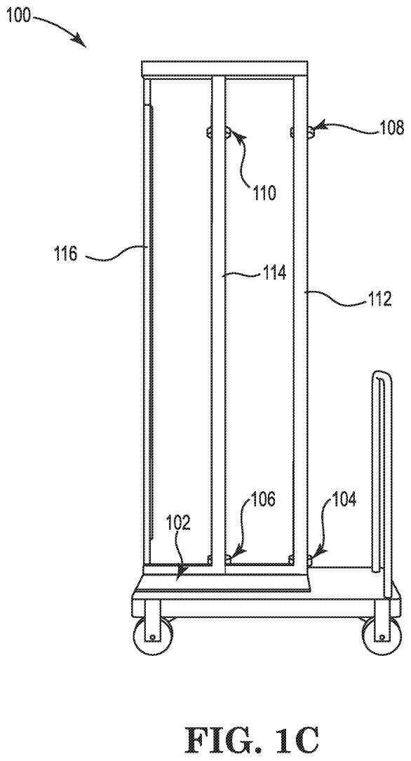

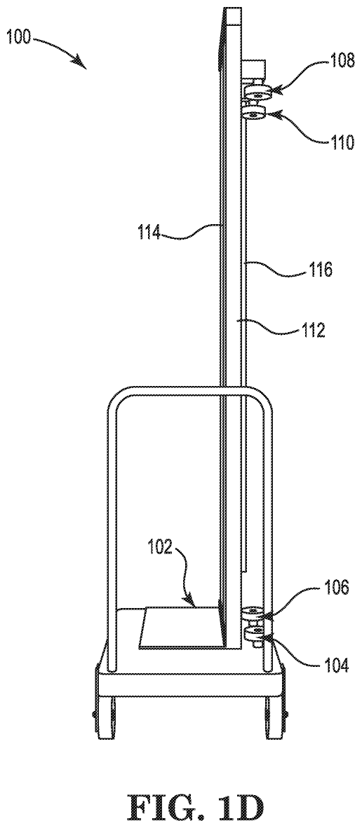

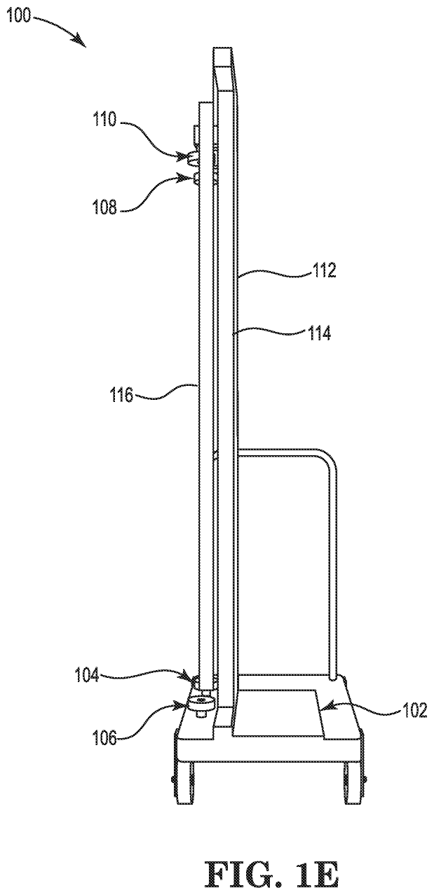

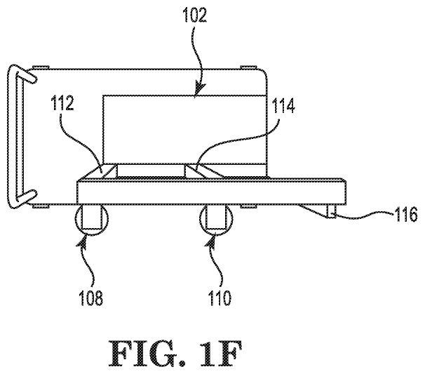

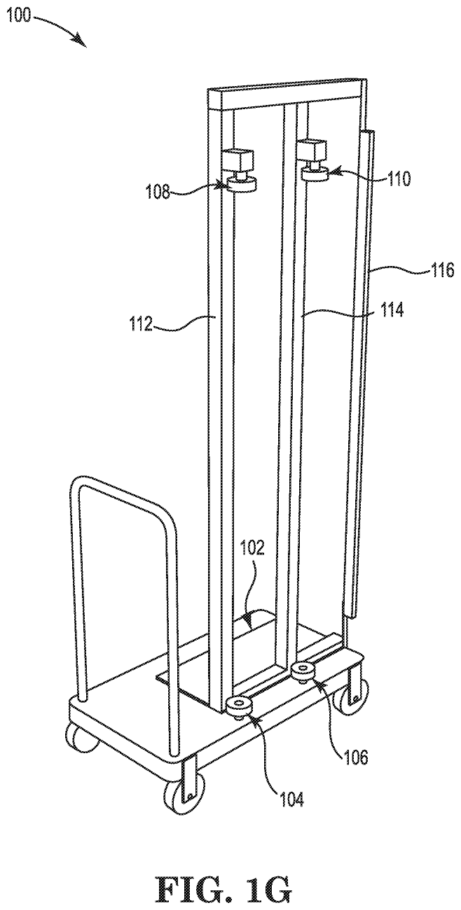

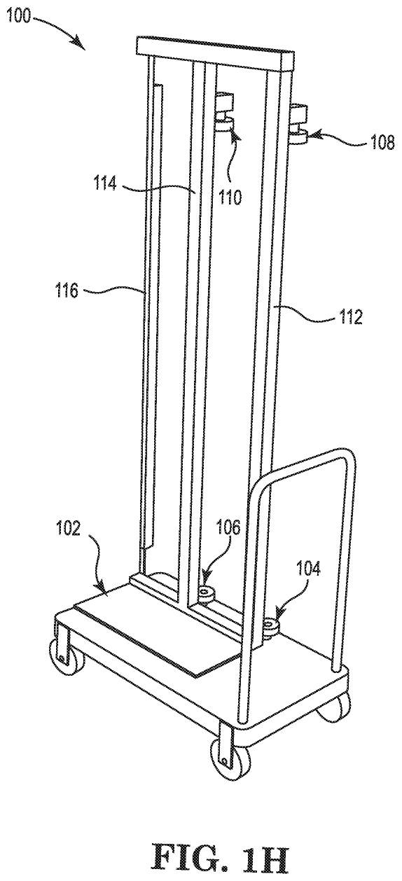

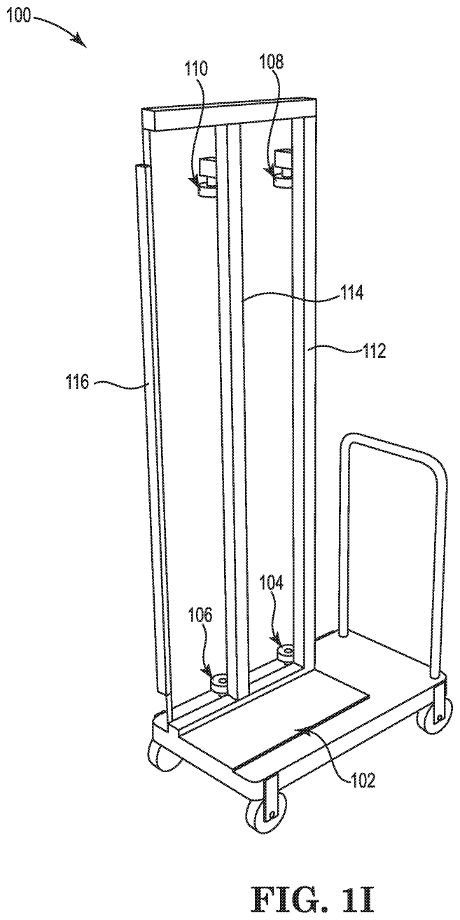

FIGS. 1A-1I illustrate an exemplary unwind assembly fixture according to the invention. As detailed in FIG. 1A, the unwind assembly fixture 100 is mounted on a mobile lift table 102 supporting first and second film holder/winder mechanisms 104, 106 that are interposed beneath corresponding first and second film holders 108, 110. At least one of the film holders 108, 110 or the respective film holder/winder mechanisms 104, 106 is preferably vertically adjustable to accommodate different widths of rolls of multi-layer sheet. In an exemplary embodiment, the first and second film holders 108, 110 are vertically adjustable as such and respectively positioned on longitudinally extending first and second support bars 112, 114.

In one embodiment, a rolled multi-layer sheet can be positioned at a desired height for dispensing and application of polymeric film or laminate therefrom onto a surface by using the mobile lift table 102 or any other suitable method for adjusting height as such. According to an exemplary aspect of this embodiment, the unwind assembly fixture is mounted on a mobile lift table that is vertically repositionable a distance of up to about fifteen centimeters. According to a further aspect of this embodiment, the unwind assembly fixture is mounted on a mobile lift table that is vertically repositionable a distance of up to about thirty centimeters. According to yet another aspect of this embodiment, the unwind assembly fixture is mounted on a mobile lift table that is vertically repositionable a distance of up to about sixty centimeters. Advantageously, the ability to adjust the height at which the release liner unwinds from the multi-layer sheet reduces the conventional requirement for additional installers—and, hence, labor costs—otherwise needed to maintain the polymeric film or laminate at the proper height for effective and efficient application to a surface.

According to a further aspect of this embodiment, the mobile lift table is equipped with motorized propulsion that facilitates forward movement of the unwind assembly fixture mounted on the cart as the polymeric film or laminate therefrom is incrementally dispensed behind. Instead of the conventional practice of unwinding an entire length of material required all at once, and hence exposing the adhesive layer to potential debris and other problematic factors, the mobile lift table 102 can be moved forward as application proceeds, simultaneously unwinding (and exposing the adhesive layer on) only a relatively confined amount of material. This is particularly advantageous for application of large sheets (e.g., those where length of the multi-layer sheet is greater than its width, particularly those having a width greater than that of the arm span of a typical installer).

In an exemplary embodiment, the unwind assembly fixture is configured for dispensing and application of sheets having a width of at least sixty centimeters. In a further exemplary embodiment, the unwind assembly fixture is configured for dispensing and application of sheets having a width of at least ninety centimeters. In yet a further exemplary embodiment, the unwind assembly fixture is configured for dispensing and application of sheets having a width of at least one-hundred, twenty centimeters. In still a further exemplary embodiment, the unwind assembly fixture is configured for dispensing and application of sheets having a width of at least one-hundred, fifty centimeters. Rolls of such large sheets can have significant diameters. In one exemplary embodiment, the first film holder is configured for holding the roll of multi-layer sheet, and wherein the roll has a core diameter of at least about eight centimeters. In a further exemplary embodiment, the first film holder is configured for holding the roll of multi-layer sheet, and wherein the roll has a core diameter of at least about sixteen centimeters.

An anti-static device 116 is positioned approximately parallel to the longitudinally extending first and second support bars 112, 114 proximate to the point at which the release liner becomes detached from the multi-layer sheet during dispensing and application of a polymeric film or laminate. In a further embodiment, a dispensing mechanism (e.g., linear manifold containing a plurality of nozzles) is placed approximately parallel to the anti-static device 116 for dispensing of fluid, steam, or gas to the exposed adhesive layer of the multi-layer sheet immediately after the release liner is removed therefrom. Dispensing of such fluid, steam, or gas can facilitate more efficient application of the polymeric film or laminate onto the article's surface.

During use of the unwind assembly fixture 100, a multi-layer sheet is provided in roll form on the second film holder/winder mechanism 106. The second film holder/winder mechanism 106 is equipped with a tension control device that does not allow it to turn until a minimum film tension level is reached thereon. Such a tension control device comprises any suitable mechanism for controlling tension. Pneumatic, electric, and magnetic brakes, and even some motors, for example, are all capable of controlling tension as such. Brakes prevent unintended unrolling of the multi-layer sheet; yet, brakes also provide controlled dispensing of polymeric film or laminate from the sheet by ensuring that an appropriate tension level is achieved.

A first film holder/winder mechanism 104 is located proximate the second film holder/winder mechanism 106 to facilitate capture and re-rolling of removed (e.g., scrap) release liner onto a removal core after its removal from the multi-layer sheet when dispensing the polymeric film or laminate for application to a surface. In an exemplary embodiment, the first film holder/winder mechanism 104 is motor-driven in a tension-controlled manner and comprises any suitable mechanism for controlling tension as such. Pneumatic, electric, and magnetic clutches can be used to limit torque provided by the motor of the first film holder/winder mechanism 104. Alternatively, some motors are capable of controlling tension without requiring use of a clutch. Regardless of the specific mechanism employed, the first film holder/winder mechanism 104 operates to limit tension that can develop in the release liner as it is removed and unwound from the rolled multi-layer sheet that is securely positioned between the second film holder/winder mechanism 106 and the second film holder 110. In one embodiment, tension at which the release liner rewinds onto the removal core (i.e., a core that is empty prior to initiation of the unwind for dispensing and application) that is securely positioned between the first film holder 108 and the first film holder/wind mechanism 104 is less than the minimum tension at which primary unwind of the release liner from the multi-layer sheet from the roll securely positioned between the second film holder 110 and the second film holder/wind mechanism 106 is initiated. The differing tension prevents rewind from overpowering primary unwind of the release liner from the multi-layer sheet, which phenomenon can lead to pulling of the entire multi-layer sheet (instead of just the release liner) onto the removal core when dispensing the polymeric film or laminate thereof.

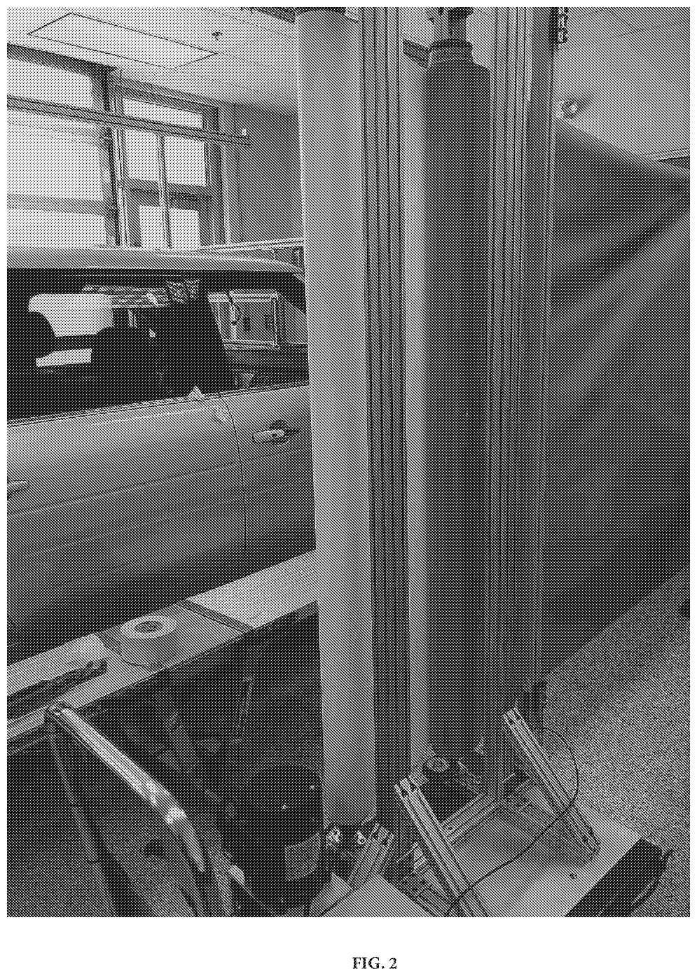

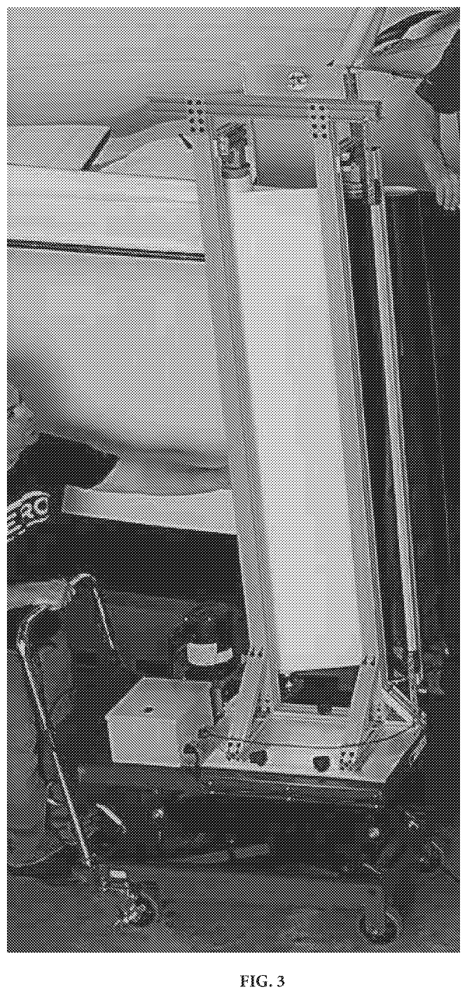

FIG. 2 illustrates use of an unwind assembly fixture according to the invention for application of polymeric film or laminates thereof to an automobile. FIG. 3 illustrates use of an unwind assembly fixture according to the invention for application of polymeric film or laminates thereof to a boat hull. As illustrated therein, a roll of multi-layer sheet is vertically positioned between a film holder/winder mechanism and a corresponding film holder proximate a support bar. As the multi-layer sheet is unwound from its roll by an installer, a release liner is separated from the polymeric film or laminate thereof and wound onto a roll vertically positioned between the other film holder/winder mechanism and its corresponding film holder proximate another support bar. During the unwind from one roll and simultaneous wind of the release liner onto another roll, the multi-layer sheet passes by an anti-static device, which anti-static device electrically and physically contacts the multi-layer sheet across its vertical width in the embodiment illustrated. In an alternative embodiment, the anti-static device electrically and physically contacts the polymeric film across its vertical width after removal of the release liner from a multi-layer sheet comprising the polymeric film.

Unwind assembly fixtures of the invention and associated methods can be used to apply polymeric film or laminates comprising the same to a wide variety of articles. Applications are numerous and widespread. In an exemplary embodiment, the article to which the multi-layer sheet is applied is a cargo container. In another exemplary embodiment, the article to which the multi-layer sheet is applied is a marine vessel, particularly the hull thereof, such as a boat hull. In yet another exemplary embodiment, the article to which the multi-layer sheet is applied is a land-based passenger vehicle, such as an automobile. Not only do unwind assembly fixtures of the invention facilitate controlled removal of the release liner and mitigate negative effects from tribocharging issues during application of polymeric film and laminates, they also facilitate improved installation on surfaces of articles and can reduce the number of installers needed for application of large sheets (e.g., those where length of the multi-layer sheet is greater than its width, particularly those having a width greater than that of the arm span of a typical installer) comprising the polymeric film or laminates thereof.

Various modifications and alterations of the invention will become apparent to those skilled in the art without departing from the spirit and scope of the invention, which is defined by the accompanying claims. It should be noted that steps recited in any method claims below do not necessarily need to be performed in the order that they are recited unless expressly stated otherwise. Those of ordinary skill in the art will recognize variations in performing the steps from the order in which they are recited. In addition, the lack of mention or discussion of a feature, step, or component provides the basis for claims where the absent feature or component is excluded by way of a proviso or similar claim language.

Further, as used throughout, ranges may be used as shorthand for describing each and every value that is within the range. Any value within the range can be selected as the terminus of the range. Similarly, any discrete value within the range can be selected as the minimum or maximum value recited in describing and claiming features of the invention.

1. An unwind assembly fixture useful for application of a polymeric film laminate to a surface of an article after removal of a release liner from a roll of multi-layer sheet comprising the polymeric film laminate, the fixture comprising:
first and second longitudinally extending support bars;
first and second film holders respectively disposed proximate upper ends of the first and second longitudinally extending support bars;
first and second film holder/winder mechanisms respectively disposed proximate lower ends of the first and second longitudinally extending support bars, wherein the second film holder/winder mechanism facilitates unwind of the multi-layer sheet from a roll and the first film holder/winder mechanism facilitates capture and re-rolling of the release liner after its removal from the roll of multi-layer sheet; and
an anti-static device positioned approximately parallel to the first and second longitudinally extending support bars and spaced apart from the second support bar on a side opposite the first support bar and proximate a point at which the release liner is removed from the roll of multi-layer sheet during dispensing of the polymeric film laminate for application to the surface of the article.

2. The unwind assembly fixture of claim 1, wherein the fixture is mounted in a portable manner on a vehicle.

3. The unwind assembly fixture of claim 2, wherein the vehicle on which the fixture is mounted is a mobile lift table.

4. The unwind assembly fixture of claim 3, wherein the mobile lift table is vertically repositionable a distance of up to about sixty centimeters.

5. The unwind assembly fixture of claim 2, wherein the vehicle is equipped with motorized propulsion to facilitate forward movement of the unwind assembly fixture as the polymeric film or laminate therefrom is incrementally dispensed behind.

6. The unwind assembly fixture of claim 1, wherein at least one of the first and second film holders is vertically adjustable.

7. The unwind assembly fixture of claim 1, wherein the first film holder is configured for holding the roll of multi-layer sheet, and wherein the roll has a core diameter of at least about eight centimeters.

8. The unwind assembly fixture of claim 1, wherein the first film holder is configured for holding the roll of multi-layer sheet, and wherein the roll has a core diameter of at least about sixteen centimeters.

9. The unwind assembly fixture of claim 1, wherein at least one of the first and second film holder/winder mechanisms is motor-driven.

10. The unwind assembly fixture of claim 1, wherein each of the first and second film holder/winder mechanisms is motor-driven.

11. The unwind assembly fixture of claim 1, wherein torque generated by the second film holder/winder mechanism is insufficient to cause unwind of the multi-layer sheet from the roll via the first film holder/winder mechanism.

12. The unwind assembly fixture of claim 1, wherein at least one of the first and second film holder/winder mechanisms employs a brake for tension control.

13. The unwind assembly fixture of claim 1, further comprising a dispensing mechanism for dispensing of a fluid, steam, or gas onto an exposed adhesive layer of the multi-layer sheet immediately after the release liner is removed therefrom.

14. The unwind assembly fixture of claim 13, wherein the dispensing mechanism comprises a linear manifold comprising a plurality of nozzles.

15. The unwind assembly fixture of claim 1, wherein the roll of multi-layer sheet has a width of at least about sixty centimeters.

16. An unwind assembly fixture useful for application of polymeric film or laminate to a surface of an article, comprising:
a film holder for mounting of a multi-layer sheet in roll form; and
an anti-static device that extends across width of the multi-layer sheet or a portion thereof during unwind of the multi-layer sheet from the roll.

17. The unwind assembly fixture of claim 16, wherein the anti-static device comprises an anti-static bar generating an electrical field for electrical contact of the polymeric film or laminate.

18. The unwind assembly fixture of claim 16, wherein the anti-static bar physically contacts the polymeric film or laminate.

19. The unwind assembly fixture of claim 16, further comprising a second film holder for capture and re-rolling of release liner after its removal from the multi-layer sheet.

20. The unwind assembly fixture of claim 16, wherein the film holder is vertically adjustable.

21. A method for application of polymeric film or laminate to at least a portion of a surface of an article, the method comprising:
providing the unwind assembly fixture of claim 1;
securing the roll of multi-layer sheet between the second film holder and the second film holder/winder mechanism;
unwinding the multi-layer sheet from the roll;
removing the release liner from the multi-layer sheet after it is unwound from the roll;
capturing and re-rolling the removed release liner on a roll positioned between the first film holder/winder mechanism and the first film holder; and
applying the polymeric film laminate to the surface of the article.

22. The method of claim 21, wherein the article comprises a cargo container.

23. The method of claim 21, wherein the article comprises a marine vessel.

24. The method of claim 21, wherein the article comprises a land-based passenger vehicle.
